(19) United States
(12) Patent Application Publication
(10) Pub. No.: US 2021/0301106 A1
(43) Pub. Date: Sep. 30, 2021

(54) COMPOSITE, MOLDED PRODUCT, AND METHOD FOR PRODUCING MOLDED PRODUCT

(71) Applicant: SEIKO EPSON CORPORATION, Tokyo (JP)

(72) Inventors: Shinobu YOKOKAWA, Okaya (JP); Hideki TANAKA, Chino (JP); Yoko NAKAI, Chino (JP); Naotaka HIGUCHI, Suwa-gun (JP); Shunichi SEKI, Suwa (JP)

(21) Appl. No.: 17/215,061

(22) Filed: Mar. 29, 2021

(30) Foreign Application Priority Data
Mar. 30, 2020 (JP) 2020-059825

(51) Int. Cl. C08L 3/02; C08L 1/02; C08J 5/18

(52) U.S. Cl. CPC C08L 3/02; C08L 1/02; C08J 5/18; C08J 2403/02; C08J 2301/02; C08J 2303/02; C08J 2401/02; C08L 2205/16

(57) ABSTRACT

A composite of the present disclosure includes a fiber, and starch, in which at least a part of the starch is fused to the fiber, and a weight-average molecular weight of the starch is 40,000 or higher and 400,000 or lower. A method for producing a molded product of the present disclosure includes a molding raw material preparing step of preparing a molding raw material containing a fiber and a starch that has a weight-average molecular weight of 40,000 or higher and 400,000 or lower, a humidifying step of humidifying the molding raw material, and a molding step of molding the molding raw material into a predetermined shape by heating and pressurizing the molding raw material.

The present application is based on, and claims priority from JP Application Serial Number 2020-059825, filed Mar. 30, 2020, the disclosure of which is hereby incorporated by reference herein in its entirety.

### BACKGROUND

### 1. Technical Field

The present disclosure relates to a composite, a molded product, and a method for producing a molded product.

### 2. Related Art

As a method for producing a sheet-shaped or film-shaped molded product using a fiber-shaped substance, there is a papermaking method using water.

In such a papermaking method, fibers are entangled with each other by using a bonding force such as a hydrogen bond between the fibers, and sufficient strength in the molded product is obtained through the bonding force.

However, in the papermaking method, it is necessary to use a large amount of water, and dehydration and drying are required during the production, so that energy and time consumption consumed for performing the papermaking method are very large. In addition, the water that has been used must be properly treated as water to be discharged. In addition, a device used in the papermaking method often requires large-scale utilities or infrastructures such as water, electric power, and water discharging facilities, and it is difficult to reduce sizes thereof.

Therefore, as a method that does not use a large amount of water as in the papermaking method of the related art, it is proposed that a method for producing a sheet by accumulating a mixture of dried fibers and a resin, and heating and pressurizing the accumulated mixture (for example, International Publication No. WO2018/043034).

In the method described in International Publication No. WO2018/043034, the strength of the sheet that is a molded product is ensured by using a resin such as a polyester resin for binding the fibers to each other.

In recent years, it is demanded to suppress the use of petroleum-derived materials in order to deal with environmental problems and saving of underground resources.

On the other hand, in the disclosure described in International Publication No. WO2018/043034, a synthetic resin is used for binding fibers.

In order to respond to the above demands, natural materials such as a material derived from a plant may be used, but in the disclosure described in International Publication No. WO2018/043034, sufficient binding force cannot be obtained when simply using the natural material instead of a synthetic resin, and it is difficult to make sheet strength sufficiently excellent. When the natural material is used instead of the synthetic resin, processability is lowered in general, and there is a problem that heating temperature needs to be increased. In addition, it is difficult to recycle the molded product.

### SUMMARY

The present disclosure can be realized in the following aspects or application examples.

A composite according to this application example of the present disclosure contains a fiber and a starch, in which at least a part of the starch is fused to the fiber, and a weight-average molecular weight of the starch is 40,000 or higher and 400,000 or lower.

A molded product according to this application example of the present disclosure includes a composite according to the present disclosure.

A method for producing a molded product according to this application example of the present disclosure includes a molding raw material preparing step of preparing a molding raw material containing a fiber and a starch that has a weight-average molecular weight of 40,000 or higher and 400,000 or lower; a humidifying step of humidifying the molding raw material; and a molding step of molding the molding raw material into a predetermined shape by heating and pressurizing the molding raw material.

### BRIEF DESCRIPTION OF THE DRAWINGS

FIG. 1 is a schematic enlarged view illustrating a preferable embodiment of a composite of the present disclosure.

FIG. 2 is a schematic side view illustrating a preferable embodiment of a molded product producing device.

### DESCRIPTION OF EXEMPLARY EMBODIMENTS

Hereinafter, preferred embodiments of the present disclosure will be described in detail.

### 1. Composite

First, a composite of the present disclosure will be described.

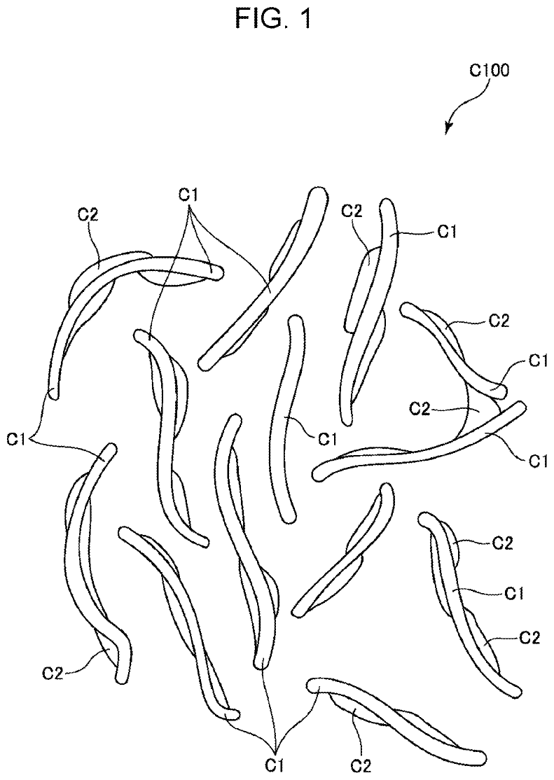

FIG. 1 is a schematic enlarged view illustrating a preferred embodiment of a composite of the present disclosure.

A composite C100 of the present disclosure contains a fiber C1 and a starch C2, and at least a part of the starches C2 is fused to the fiber C1. A weight-average molecular weight of the starch C2 is 40,000 or higher and 400,000 or lower.

By using the composite C100, it is possible to suitably produce a molded product having a desired shape by using only a small amount of water while suppressing the use of petroleum-derived materials. That is, a dry molding method can be suitably applied. Therefore, it is also advantageous from the viewpoints of productivity and production cost of the molded product, energy saving, miniaturization of the production facility of the molded product, and the like. By using the starch having a predetermined molecular weight as described above, water absorbability is improved, and even through a small amount of water is added, pregelatinization by heating suitably proceeds. As a result, the molded product, which is formed using the composite C100 and has an excellent productivity, can be obtained. The starch C2 having a predetermined molecular weight as described above is suitably pregelatinized by heating with a small amount of water, and also a non-covalent bond such as a hydrogen bond acts between the starch C2 and the fiber C1 to have an excellent bonding force between the starch C2 and the fiber C1, so that the starch C2 exhibits an excellent coating property with respect to the fiber C1. Therefore, the strength of the molded product produced using the composite C100 can be excellent. Since the starch C2 having a predetermined molecular weight as described above are unlikely to undergo unintended denaturation due to the addition of moisture, the molded product produced using the composite C100 is excellent in recyclability. In addition, it is possible to more effectively prevent the fibers C1 from scattering during the production of the molded product by using the composite C100. Such the composite C100 and the molded product produced using the composite C100 are also excellent in biodegradability. Since the binding force of the starch can be exhibited with a small amount of moisture, it is also excellent in recyclability when the molded product is dry-produced again using the produced molded product. The recyclability referred to here refers to a degree of deterioration in the performance of the produced molded product when a dry molded product is produced again from a raw material obtained by defibrating the molded product containing the fibers and the starch. That is, when the reproduced molded product has excellent tensile strength and the like, recyclability is excellent, and when the reproduced molded product deteriorates in tensile strength and the like, recyclability also deteriorates.

On the other hand, when the above conditions are not satisfied, a satisfactory result cannot be obtained.

For example, even in the case of the composite containing the fibers and the starch fused to the fibers, when the weight-average molecular weight of the starch is lower than a lower limit, the strength of the molded product produced by using the composite cannot be sufficiently excellent.

In addition, even in the case of the composite containing the fibers and the starch fused to the fibers, when the weight-average molecular weight of the starch is higher than an upper limit, the water absorbability of the starch decreases, so that the starch is necessary to treat with a large amount of water in advance before heating. As a result, it is not preferable from the viewpoints that the productivity and production cost of the molded product using the composite significantly deteriorate, the large-scale production facility of the molded product is also required, and energy saving is reduced. In addition, the recyclability of the molded product produced by using the composite is significantly reduced.

The weight-average molecular weight of the starch C2 can be determined by measurement with gel permeation chromatography. The weight-average molecular weight illustrated in Examples described later is also a value determined by measurement with gel permeation chromatography. In the present disclosure, the dry molding method refers to a method in which a molding raw material is not immersed in a liquid containing water in a process of producing a molded product, and a method in which a small amount of water is used, for example, a method for spraying a liquid containing water on a molding raw material or the like are also included in the dry molding method.

### 1-1. Fiber

The composite C100 contains the fiber C1.

The fiber C1 is usually a main component of the molded product produced using the composite C100, is a component that greatly contributes to the maintenance of the shape of the molded product, and has a great influence on the properties such as the strength of the molded product.

The fiber C1 is preferably formed of a substance containing at least one chemical structure of a hydroxyl group, a carbonyl group, and an amino group.

Thereby, the hydrogen bond between the fiber C1 and the starch C2 described in detail later is likely to be formed, so that the bonding strength between the fiber C1 and the starch C2, an overall strength of the molded product produced using the composite C100, for example, the tensile strength of the sheet-shaped molded product and the like can be more excellent.

The fiber C1 may be a synthetic fiber formed of a synthetic resin such as polypropylene, polyester, or polyurethane, but is preferably a naturally-derived fiber, that is, a biomass-derived fiber, and more preferably a cellulose fiber.

Thereby, it is possible to more suitably deal with environmental problems and saving of underground resources.

In particular, when the fiber C1 is a cellulose fiber, the following effects can be obtained.

That is, cellulose is a natural material derived from plants and is an abundant resource. By using cellulose as fibers constituting the composite C100, it is possible to more suitably deal with environmental problems and saving of underground resources, and the composite is also available, and it is also preferable from the viewpoint of a stable supply of the composite C100 and the molded product produced using the composite C100, cost reduction, and the like. Cellulose fibers have a particularly high theoretical strength among various fibers, and are advantageous from the viewpoint of further improving the strength of the molded product.

Cellulose fibers are usually mainly constituted of cellulose, but may contain components other than cellulose. Examples of the component include hemicellulose, lignin, and the like.

Cellulose fibers that have been subjected to a treatment such as bleaching may be used.

The fiber C1 may be a fiber that has been treated by ultraviolet irradiation treatment, ozone treatment, plasma treatment, or the like. Thereby, hydrophilicity of the fiber C1 can be increased, and affinity with the starch C2 can be increased. More specifically, by performing these treatments, a functional group such as a hydroxyl group can be introduced on a surface of the fiber C1, and a hydrogen bond between the fiber C1 and the starch C2 can be more efficiently formed.

The composite C100 contains the starch C2 in addition to the fiber C1, and at least a part of the starch C2 is fused to the fiber C1, but the composite C100 may also contain a fiber C1 to which the starch C2 is not fused in addition to the fiber C1 to which the starch C2 is fused.

An average length of the fiber C1 is not particularly limited, but is preferably 0.1 mm or higher and 50 mm or lower, more preferably 0.2 mm or higher and 5.0 mm or lower, and even more preferably 0.3 mm or higher and 3.0 mm or lower.

Thereby, stability, strength, and the like of the shape of the molded product produced using the composite C100 can be made more excellent.

An average thickness of the fiber C1 is not particularly limited, but is preferably 0.005 mm or higher and 0.5 mm or lower, and more preferably 0.010 mm or higher and 0.05 mm or lower.

Thereby, stability, strength, and the like of the shape of the molded product produced using the composite C100 can be made more excellent. It is possible to more effectively prevent unintended unevenness on the surface of the molded product produced using the composite C100.

An average aspect ratio of the fiber C1, that is, a ratio of the average length to the average thickness is not particularly limited, but is preferably 10 or higher and 1000 or lower, and more preferably 15 or higher and 500 or lower.

Thereby, stability, strength, and the like of the shape of the molded product produced using the composite C100 can be made more excellent. It is possible to more effectively prevent unintended unevenness on the surface of the molded product produced using the composite C100.

A content of the fiber C1 in the composite C100 is not particularly limited, but is preferably 60.0% by mass or more and 99.0% by mass or less, more preferably 85.0% by mass or more and 98.0% by mass or less, and even more preferably 88.0% by mass or more and 97.0% by mass or less.

Thereby, properties such as stability and strength of the shape of the molded product produced using the composite C100 can be made more excellent. In addition, moldability when producing the molded product can be made more excellent, which is also advantageous in improving the productivity of the molded product.

### 1-2. Starch

The composite C100 contains the starch C2 having a predetermined weight-average molecular weight as described above.

The starch C2 is a component that functions as a binder that binds fibers C1 to each other in the molded product produced using the composite C100. In particular, since the starch C2 is a raw material derived from biomass, it is possible to suitably deal with environmental problems and saving of underground resources by using the starch C2. The starch C2 has a predetermined weight-average molecular weight as described above, so that the water absorbability is improved, and when moisture is added, the moisture can be rapidly absorbed. In addition, the starch can be suitably pregelatinized at a relatively low temperature with a small amount of moisture with respect to the amount of the starch, and an excellent binding property can be exhibited.

The starch C2 is a polymer material in which a plurality of a-glucose molecules are bonded by glycosidic bonds.

The starch C2 contains at least one of amylose or amylopectin.

As described above, the weight-average molecular weight of the starch C2 is 40,000 or higher and 400,000 or lower, preferably 60,000 or higher and 350,000 or lower, and more preferably 80,000 or higher and 300,000 or lower.

Thereby, the above described effect is more remarkably exhibited.

The starch C2 as described above has a smaller molecular weight than an ordinary starch.

The starch C2 whose weight-average molecular weight is controlled to be within a predetermined range in this way can be suitably obtained by performing a process, for example, such that sulfuric acid, hydrochloric acid, or sodium hypochlorite after suspending in water acts on a natural starch under a condition in which the starch does not gelatinize, or such that a natural starch is directly added or is added with a very small amount of volatile acid such as hydrochloric acid diluted with water, and the mixture is mixed well, aged, and dried at a low temperature, and then heated to 120° C. to 180° C., or such that paste obtained by heating a natural starch with water is hydrolyzed with an acid or enzyme.

As the natural starch used as a raw material of the starch C2, for example, a starch derived from various plants can be used, and more specifically, a starch derived from, for example, grains such as corn, wheat, and rice, beans such as broad beans, mung beans, red beans, potatoes such as potatoes, sweet potatoes, tapioca, wild grasses such as erythronium, bracken, and kudzu, or palms such as sago palms can be used.

As described above, the composite C100 contains the starch C2 in addition to the fiber C1, and at least a part of the starch C2 is fused to the fiber C1, but the composite C100 may also contain a starch C2 that is not fused to the fiber C1 in addition to the starch C2 that is fused to the fiber C1.

A content of the starch C2 with respect to a total amount of the composite C100 is preferably 0.5% by mass or more and 40.0% by mass or less, more preferably 2.0% by mass or more and 15.0% by mass or less, and even more preferably 3.0% by mass or more and 10.0% by mass or less.

Thereby, the water absorbability of the composite C100 can be particularly excellent, and properties such as stability and strength of the shape of the molded product produced using the composite C100 can be made more excellent. In addition, moldability when producing the molded product can be made more excellent, which is also advantageous in improving the productivity of the molded product.

The content of the starch C2 in the composite C100 with respect to 100 parts by mass of the fiber C1 is preferably 0.5 parts by mass or more and 66.7 parts by mass or less, more preferably 2.0 parts by mass or more and 17.7 parts by mass or less, and even more preferably 3.1 parts by mass or more and 11.1 parts by mass or less.

Thereby, properties such as stability and strength of the shape of the molded product produced using the composite C100 can be made more excellent. In addition, moldability when producing the molded product can be made more excellent, which is also advantageous in improving the productivity of the molded product.

### 1-3. Other Components

The composite C100 may contain components other than the fiber C1 and the starch C2 described above.

Examples of the components include natural gum pastes such as etherified tamarind gum, etherified locust bean gum, etherified guar gum, and acacia arabia gum; fiber element-inducing pastes such as etherified carboxymethyl cellulose and hydroxyethyl cellulose; polysaccharides such as glycogen, hyaluronic acid, etherified starch, and esterified starch; seaweeds such as sodium alginate and agar; animal proteins such as collagen, gelatin, and hydrolyzed collagen; sizing agents; impurities derived from the fibers C1; impurities derived from the starch C2; and the like.

However, a content of components other than the fiber C1 and the starch C2 in the composite C100 is preferably 10% by mass or less, more preferably 5.0% by mass or less, and even more preferably 2.0% by mass or less.

A moisture content of the composite C100 when being left for 2 hours in an environment of 27° C./98% RH is preferably 20% by mass or more and 55% by mass or less, more preferably 22% by mass or more and 50% by mass or less, and even more preferably 25% by mass or more and 40% by mass or less.

Thereby, a moisture content is increased by mixing the fiber and the starch, a water absorption rate of the composite can be improved, and water can be uniformly supplied to the inside of the composite.

Regarding the measurement of the moisture content described above, the moisture content can be measured as follows. For example, 0.7 g of the composite C100 is separated, the composite is sieve-laminated on cooking paper in a disk shape using an automatic powder sieve M made of raffine stainless steel, which is manufactured by Pearl Metal Co., Ltd., the sieve-laminated composite is placed onto a pishat mesh basket made of stainless steel (manufactured by shinetsu works) with the cooking sheet, and the moisture content can be measured using a heat-drying moisture meter (MX-50 manufactured by A&B Inc.) and the like under conditions of using a constant temperature bath (constant temperature and humidity device Platinous (registered trademark) K series PL-3KPH manufactured by ESPEC CORP.), and being left for 2 hours in an environment set at 27° C./98% RH. A moisture content of the composite when being left in an environment of 27° C./98% RH illustrated in Examples described later for 2 hours is also a value obtained by performing the measurement under the above conditions.

### 2. Molded Product

Next, the molded product of the present disclosure will be described.

The molded product of the present disclosure is configured to include the above described composite C100 of the present disclosure.

Thereby, it possible to provide the molded product having a desired shape while suppressing the use of petroleum-derived materials. Such the molded product is also excellent in biodegradability. Such the molded product is also excellent in recyclability, strength, and the like.

A shape of the molded product of the present disclosure is not particularly limited, and may be any shape such as a sheet shape, a block shape, a spherical shape, a three-dimensional shape, and the like, but the molded product of the present disclosure preferably has a sheet shape. The sheet shape described herein refers to a molded product molded to have a thickness of 30 μm or higher and 30 mm or lower and a density of 0.05 g/cm³ or higher and 1.5 g/cm³ or lower.

Thereby, for example, the molded product can be suitably used as a recording medium or the like. In addition, by using a producing method and a producing device as described later, the molded product is more efficiently produced.

When the molded product of the present disclosure is a sheet-shaped recording medium, a thickness thereof is preferably 30 μm or higher and 3 mm or lower.

Thereby, the molded product can be suitably used as a recording medium. In addition, by using a producing method and a producing device as described later, the molded product is more efficiently produced.

When the molded product of the present disclosure is a liquid absorber, a thickness thereof is preferably 0.3 mm or higher and 30 mm or lower.

Thereby, the molded product can be suitably used as a liquid absorber. In addition, by using a producing method and a producing device as described later, the molded product is more efficiently produced.

When the molded product of the present disclosure is a sheet-shaped recording medium, a density thereof is preferably 0.6 g/m³ or higher and 0.9 g/m³ or lower.

Thereby, the molded product can be suitably used as a recording medium.

When the molded product of the present disclosure is a liquid absorber, a density thereof is preferably 0.05 g/m³ or higher and 0.4 g/m³ or lower.

Thereby, the molded product can be suitably used as a liquid absorber.

At least a part of the molded product of the present disclosure may be formed of the above described composite C100 of the present disclosure, and may have a portion that is not formed of the composite 0100 of the present disclosure.

The application of the molded product of the present disclosure is not particularly limited, and examples thereof include a recording medium, a liquid absorber, a buffer material, a sound absorbing material, and the like.

The molded product of the present disclosure, which has been subjected to machining such as cutting or various chemical treatments after the molding step, may be used.

### 3. Method for Producing Molded Product

Next, a method for producing a molded product of the present disclosure will be described.

The method for producing a molded product of the present disclosure includes a molding raw material preparing step of preparing a molding raw material containing a fiber and a starch that has a weight-average molecular weight of 40,000 or higher and 400,000 or lower, a humidifying step of humidifying the molding raw material, and a molding step of molding the molding raw material into a predetermined shape by heating and pressurizing the molding raw material.

Thereby, it possible to provide the method for producing a molded product, through which the molded product having a desired shape can be suitably produced while suppressing the use of petroleum-derived materials even with adding almost no moisture. Therefore, it is also advantageous from the viewpoints of productivity and production cost of the molded product, energy saving, miniaturization of the production facility of the molded product, and the like. The molded product produced by using the producing method of the present disclosure is also excellent in biodegradability. The molded product produced by using the method of the present disclosure can be easily recycled. In addition, the strength of the molded product can be made excellent, and the scattering of fibers during the production of the molded product can be prevented more effectively.

### 3-1. Molding Raw Material Preparing Step

In the molding raw material preparing step, a molding raw material containing a fiber and a starch that has a weight-average molecular weight of 40,000 or higher and 400,000 or lower is prepared.

The fiber constituting the molding raw material preferably satisfies the same conditions as described in the above 1-1.

Thereby, the above described effect can be obtained.

The starch constituting the molding raw material may have a weight-average molecular weight of 40,000 or higher and 400,000 or lower, but preferably satisfies the same conditions as described in the above 1-2.

Thereby, the above described effect can be obtained.

When the molding raw material contains a starch in particle form, an average particle size of the starch is preferably 1 μm or higher and 100 μm or lower, more preferably 3 μm or higher and 50 μm or lower, and even more preferably 5 μm or higher and 30 μm or lower.

Thereby, the ease of handling and fluidity of the starch can be made more suitable, and the molding raw material can be more suitably prepared. In addition, it is possible to more effectively prevent the starch from being unintentionally separated from the molding raw material in a state where the fiber and the starch are mixed.

In the present specification, an average particle size is a volume-based average particle size, and can be determined by, for example, adding a sample to a dispersion medium in which the sample does not dissolve or swell, and measuring a dispersion liquid dispersed by an ultrasonic dispersion instrument for 3 minutes with an aperture of 50 μm in a particle size distribution measuring instrument (TA-II Type manufactured by COULTER ELECTRONICS INC) using a Coulter counter method.

The molding raw material may contain other components in addition to the fiber and the starch as described above. Examples of such components include the components described in 1-3 above.

The molding raw material used in the method for producing a molded product of the present disclosure may contain the fiber and the starch having a weight-average molecular weight of 40,000 or higher and 400,000 or lower, but is preferably the composite of the present disclosure described above. That is, the molding raw material includes a fiber, and a starch, in which at least a part of the starch is fused to the fiber, and a weight-average molecular weight of the starch is preferably 40,000 or higher and 400,000 or lower.

Thereby, a starch is effectively prevented from being unintentionally separated in a process of producing a molded product, for example, in steps of forming a fiber raw material M1 to a first web M5 in a method using a molded product producing device 100 as described later, and a molded product containing a starch can be more reliably obtained in a preferable form and amount.

When the molding raw material is the composite of the present disclosure described above, it is preferable that the molding raw material satisfies the same conditions as described in the above 1.

Thereby, the above described effect can be obtained.

In particular, the molding raw material preferably contains a defibrated material of the composite formed in a sheet shape containing a fiber and a starch.

Thereby, the defibrated material usually has a cotton-like shape, and can be more suitably adapted to the production of molded products having various shapes and thicknesses. By using the sheet-shaped composite as a raw material for the defibrated material, the molding raw material is easily prepared. The molding raw material can be easily prepared from the sheet-shaped composite as only the required amount when needed, so that a space required for storing the raw material can be reduced, thereby also contributing to miniaturization of the molded product producing device. When the sheet-shaped composite is waste paper used as a recording medium or the like, and a sheet-shaped molded product is produced therefrom, the number of times of reusing the composite and the number of times of recycling can be more suitably increased, which is preferable.

### 3-2. Humidifying Step

In the humidifying step, the molding raw material is humidified.

Thereby, in the molding step described later, a bonding strength between the fiber and the starch, and a bonding strength between the fibers via the starch can be excellent, and the strength of the finally obtained molded product can be sufficiently excellent. In addition, molding in the molding step can be suitably performed under relatively mild conditions.

A method of humidifying the molding raw material is not particularly limited, but is preferably performed in a non-contact manner with respect to the molding raw material. Examples of the method include a method of placing a molding raw material in a high humidity atmosphere, a method of passing a molding raw material through a high humidity space, a method of spraying a mist of a liquid containing water on a molding raw material, a method of passing a molding raw material through a space where a mist of a liquid containing water floats, and the like, and one method can be performed singly or two or more methods selected from the above methods can be performed in combination. The liquid containing water may contain, for example, an antiseptic agent, an antifungal agent, an insecticide, or the like.

Humidification of the molding raw material may be performed through a plurality of steps in a process of producing the molded product, for example.

More specifically, for example, among humidification for a sheet-shaped composite containing a fiber and a starch, humidification for a coarsely crushed piece of the sheet-shaped composite, humidification for a web obtained by accumulating the defibrated material, and humidification for the defibrated material of the sheet-shaped composite, for example, humidification for a composition containing a defibrated material obtained by defibrating a coarsely crushed piece, two ways or more of humidification may be performed in combination.

As described above, by humidifying the molding raw material at a plurality of stages in the process of producing the molded product, for example, it is not necessary to increase the humidification amount at each stage more than necessary. As a result, for example, a transportation speed of the molding raw material in the molded product producing device can be increased, and productivity of the molded product can be further improved.

The amount of moisture added to the molding raw material in the humidifying step is not particularly limited, but a moisture content of the molding raw material at the end of the humidifying step, that is, a ratio of the mass of moisture contained in the molding raw material to the mass of the molding raw material at the end of the humidifying step is preferably 15% by mass or more and 50% by mass or less, more preferably 18% by mass or more and 45% by mass or less, and even more preferably 20% by mass or more and 40% by mass or less.

Thereby, it is possible to make the starch absorb water more suitably, and the subsequent molding step can be more suitably performed. As a result, the strength, reliability, and the like of the finally obtained molded product can be more excellent. In addition, since the time required for water absorption of a starch can be relatively shortened, the productivity of the molded product can be more excellent. Furthermore, energy consumption required for heating in the subsequent molding step can be remarkably reduced as compared with the papermaking method.

The content of moisture can be determined by measurement using a heat-drying moisture meter manufactured by A&D Company, Limited.

### 3-3. Molding Step

In the molding step, the humidified molding raw material is heated and pressurized to be molded as a predetermined shape. Thereby, the molded product of the present disclosure, which is obtained by bonding fibers to each other through the starch fused to the fibers, can be obtained. The humidifying step may be performed while performing the molding step.

A heating temperature in the molding step is not particularly limited, but is preferably 60° C. or higher and 180° C. or lower, more preferably 70° C. or higher and 170° C. or lower, and even more preferably 80° C. or higher and 160° C. or lower.

Thereby, pregelatinization of the starch having absorbed moisture can suitably proceed, the constituting material of the molded product is effectively prevented from being unintentionally deteriorated, and it is also preferable from the viewpoint of energy saving. Heat resistance of the obtained molded product and the mechanical strength at a relatively low temperature such as room temperature can be more excellent. The above temperature is sufficiently lower than a case where polyester, which is a synthetic resin, is used as a binder.

The pressurization in the molding step is preferably performed at 0.1 MPa or higher and 100 MPa or lower, and more preferably 0.3 MPa or higher and 20 MPa or lower.

This step can be performed using, for example, a hot press, a hot roller, or the like.

### 3-4. Molded Product Producing Device

Next, the molded product producing device that can be suitably applied to the method for producing a molded product of the present disclosure will be described.

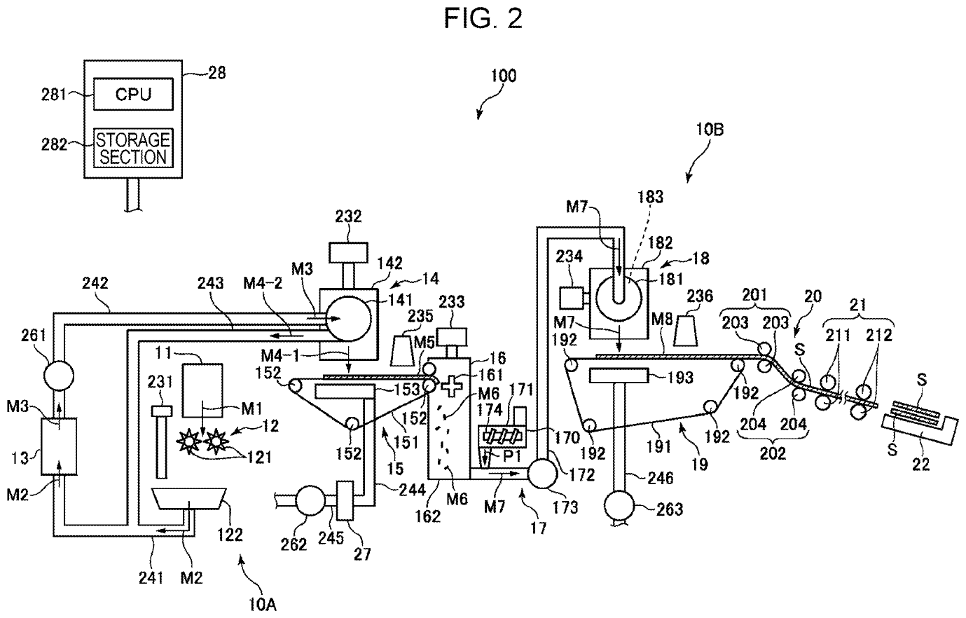

FIG. 2 is a schematic side view illustrating a preferred embodiment of the molded product producing device.

In the following, the upper side of FIG. 2 may be referred to as an “upper” or an “upper direction”, and the lower side may be referred to as a “lower” or a “lower direction”.

FIG. 2 is a schematic configuration diagram, and a positional relationship of each section of a molded product producing device 100 is different from the positional relationship illustrated in the figure. In each section in the figure, directions in which a fiber raw material M1, a coarsely crushed piece M2, a defibrated material M3, a first sorted material M4-1, a second sorted material M4-2, a first web M5, a fine fragment material M6, a mixture M7, a second web M8, and a sheet S are transported, that is, directions indicated by arrows are also referred to as transportation directions. The tip side of the arrow is also referred to as the downstream in the transportation direction, and the base end of the arrow is also referred to as the upstream in the transportation direction.

The molded product producing device 100 illustrated in FIG. 2 is a device for obtaining a molded product by coarsely crushing, defibrating, and accumulating the fiber raw material M1 and molding the accumulated material using a molding section 20.

The molded product produced by the molded product producing device 100 may have a sheet shape such as recycled paper or a block shape. A density of the molded product is not particularly limited, and a molded product having a relatively high fiber density such as a sheet may be used, a molded product having a relatively low fiber density such as a sponge body may be used, or a molded product in which these properties are mixed may be used.

As the fiber raw material M1, for example, waste paper that has been used or unnecessary waste paper can be used. For example, as the fiber raw material M1, a sheet material containing a fiber and a starch having a weight-average molecular weight of 40,000 or higher and 400,000 or lower fused to the fibers can be used. The sheet material may be, for example, recycled paper or non-recycled paper.

In the following description, a case where the molded product is a sheet S made of recycled paper will be mainly described, the molded product being produced by using waste paper which is a sheet material formed of the composite containing the fiber and the starch that has a weight-average molecular weight of 40,000 or higher and 400,000 or lower and that is fused to the fiber, as the fiber raw material M1.

The molded product producing device 100 illustrated in FIG. 2 is provided with a sheet supply device 11, a coarsely crushing section 12, a defibrating section 13, a sorting section 14, a first web forming section 15, a fragmenting section 16, a mixing section 17, a dispersing section 18, a second web forming section 19, a molding section 20, a cutting section 21, a stock section 22, a collecting section 27, and a control section 28 that controls an operation thereof. Each of the coarsely crushing section 12, defibrating section 13, sorting section 14, first web forming section 15, fragmenting section 16, mixing section 17, dispersing section 18, second web forming section 19, molding section 20, cutting section 21, and stock section 22 is a processing section that processes a sheet.

A sheet processing device 10A includes the sheet supply device 11 and the coarsely crushing section 12 or the defibrating section 13. A fiber body accumulation device 10B includes the sheet processing device 10A and the second web forming section 19.

The molded product producing device 100 is provided with a humidifying section 231, a humidifying section 232, a humidifying section 233, a humidifying section 234, a humidifying section 235, and a humidifying section 236. The molded product producing device 100 is provided with a blower 261, a blower 262, and a blower 263.

The humidifying section 231 to the humidifying section 236 and the blower 261 to the blower 263 are electrically coupled to the control section 28, and an operation thereof is controlled by the control section 28. That is, in the present embodiment, an operation of each section of the molded product producing device 100 is controlled by one control section 28. However, the present disclosure is not limited thereto, and for example, the molded product producing device 100 may include a control section that controls an operation of each section of the sheet supply device 11 and a control section that controls operations of parts other than the sheet supply device 11.

In the molded product producing device 100, a raw material supplying step, a coarsely crushing step, a defibrating step, a sorting step, a first web forming step, a fragmenting step, a mixing step, a releasing step, a accumulating step, a sheet forming step, a cutting step are executed in this order. The molding raw material preparing step in the method for producing a molded product of the present disclosure corresponds to a range from the raw material supplying step to the mixing step, and the sheet forming step corresponds to the molding step in the method for producing a molded product of the present disclosure. In addition, a step of performing humidification by each humidifying section described in detail later corresponds to the humidifying step.

A configuration of each section will be described below.

The sheet supply device 11 is a part that performs the raw material supplying step of supplying the fiber raw material M1 to the coarsely crushing section 12. As described above, as the fiber raw material M1, the composite containing a fiber and a starch having a weight-average molecular weight of 40,000 or higher and 400,000 or lower fused to the fibers can be suitably used. In particular, as the fiber raw material M1, fibers containing cellulose fibers can be suitably used.

The coarsely crushing section 12 is a part that performs the coarsely crushing step of coarsely crushing the fiber raw material M1 supplied from the sheet supply device 11 in air such as atmosphere. The coarsely crushing section 12 has a pair of coarsely crushing blades 121 and a chute 122.

The pair of coarsely crushing blades 121 can coarsely crush the fiber raw material M1 between the coarsely crushing blades by rotating in opposite directions, that is, can cut the fiber raw material M1 into a coarsely crushed piece M2. A shape and size of the coarsely crushed piece M2 are preferably suitable for a defibrating process in the defibrating section 13, for example, a small piece having one side length of 100 mm or lower is preferable, and a small piece having one side length of 10 mm or higher and 70 mm or lower is more preferable.

The chute 122 is disposed below the pair of coarsely crushing blades 121, and has a funnel shape, for example. Thereby, the chute 122 can receive the coarsely crushed pieces M2 that are coarsely crushed by the coarsely crushing blades 121 and then fallen.

Above the chute 122, the humidifying section 231 is disposed adjacent to the pair of coarsely crushing blades 121. The humidifying section 231 humidifies the coarsely crushed pieces M2 in the chute 122. The humidifying section 231 includes a filter containing moisture, and is a vaporization type humidifier that supplies humidified air with increased humidity to the coarsely crushed pieces M2 by passing the air through the filter. By supplying the humidified air to the coarsely crushed piece M2, the humidifying step described in the above 3-2 can be performed, and the above described effect can be obtained. In addition, it is possible to prevent the coarsely crushed pieces M2 from adhering to the chute 122 or the like due to static electricity.

The chute 122 is coupled to the defibrating section 13 through a tube 241. The coarsely crushed pieces M2 collected on the chute 122 pass through the tube 241 and are transported to the defibrating section 13.

The defibrating section 13 is a part that performs the defibrating step of defibrating the coarsely crushed pieces M2 in air, that is, by using a dry method. By a defibrating process in the defibrating section 13, the defibrated material M3 can be produced from the coarsely crushed piece M2. Here, “defibrating” means that the coarsely crushed piece M2 formed by binding a plurality of fibers with each other is unraveled into individual fibers. This unraveled fibers form the defibrated materials M3. A shape of the defibrated material M3 is linear or strip-shaped. Furthermore, the defibrated materials M3 may exist in a state of being intertwined and agglomerated, that is, in a state of forming a so-called “lump”.

For example, in the present embodiment, the defibrating section 13 includes an impeller mill having a rotary blade that rotates at high speed and a liner located on the outer periphery of the rotary blade. The coarsely crushed piece M2 that has flowed into the defibrating section 13 is sandwiched between the rotary blade and the liner, and is defibrated.

The defibrating section 13 can generate an air flow, that is, airstream from the coarsely crushing section 12 toward the sorting section 14 by the rotation of the rotary blade. Thereby, the coarsely crushed piece M2 can be sucked from the tube 241 to the defibrating section 13. After the defibrating process, the defibrated materials M3 can be sent out to the sorting section 14 via a tube 242.

The blower 261 is installed in the middle of the tube 242. The blower 261 is an airflow generator generating airstream toward the sorting section 14. Thereby, it is promoted that the defibrated materials M3 are sent out to the sorting section 14.

The sorting section 14 is a part that performs a sorting step of sorting the defibrated materials M3 according to sizes of the fiber length. In the sorting section 14, the defibrated material M3 is sorted into the first sorted material M4-1 and the second sorted material M4-2 which is larger than the first sorted material M4-1. The first sorted material M4-1 has a size suitable for the sheet S to be subsequently produced. An average length thereof is preferably 1 μm or higher and 30 μm or lower. On the other hand, the second sorted material M4-2 includes, for example, insufficiently defibrated materials, agglomerates generated such that the defibrated fibers are excessively agglomerated to each other.

The sorting section 14 includes a drum section 141 and a housing section 142 accommodating the drum section 141.

The drum section 141 is a cylindrical net body and is a sieve rotating about a central axis. The defibrated materials M3 flows into the drum section 141. By rotating the drum section 141, the defibrated materials M3 having a size smaller than a mesh opening are sorted as the first sorted materials M4-1, and the defibrated materials M3 having a size larger than the mesh opening is sorted as the second sorted materials M4-2. The first sorted materials M4-1 fall from the drum section 141.

On the other hand, the second sorted materials M4-2 are sent out to a tube 243 coupled to the drum section 141. The upstream of the tube 243 is coupled to a side opposite to the drum section 141, that is, coupled to the tube 241. The second sorted materials M4-2 that have passed through the tube 243 get together with the coarsely crushed pieces M2 in the tube 241 and flow into the defibrating section 13 together with the coarsely crushed pieces M2. Thereby, the second sorted materials M4-2 are returned to the defibrating section 13 and subjected to the defibrating process together with the coarsely crushed pieces M2.

The first sorted materials M4-1 to be fallen from the drum section 141 fall while being dispersed in the air, and directs toward the first web forming section 15 located below the drum section 141. The first web forming section 15 is a part that performs the first web forming step of forming the first web M5 by using the first sorted materials M4-1. The first web forming section 15 includes a mesh belt 151, three tension rollers 152, and a suction section 153.

The mesh belt 151 is an endless belt on which the first sorted materials M4-1 are accumulated. The mesh belt 151 winds around three tension rollers 152. The first sorted materials M4-1 on the mesh belt 151 is transported to the downstream by rotational drive of the tension rollers 152.

Sizes of the first sorted materials M4-1 are larger than the mesh openings of the mesh belt 151. Thereby, the first sorted materials M4-1 are restricted from passing through the mesh belt 151, and thus can be accumulated on the mesh belt 151. The first sorted materials M4-1 are transported to the downstream together with the mesh belt 151 while being accumulated on the mesh belt 151, and are formed as the first web M5 having a layered shape.

In addition, dust, dirt, and the like may be mixed between the first sorted materials M4-1. Dust and dirt may be generated in pursuance of, for example, a coarsely crushing process or a defibrating process. Such dust and dirt are collected by a collecting section 27, which will be described later.

The suction section 153 is a suction mechanism sucking air below the mesh belt 151. Thereby, the dust and dirt that have passed through the mesh belt 151 can be sucked together with the air.

The suction section 153 is coupled to the collecting section 27 through a tube 244. The dust and dirt sucked by the suction section 153 are collected by the collecting section 27.

A tube 245 is further coupled to the collecting section 27. A blower 262 is installed in the middle of the tube 245. By operating the blower 262, a suction force can be generated at the suction section 153. Thereby, it is promoted that the first web M5 on the mesh belt 151 is formed. Dust, dirt, and the like are removed from the first web M5. Dust and dirt pass through the tube 244 and reach the collecting section 27 by an operation of the blower 262.

The housing section 142 is coupled to the humidifying section 232. The humidifying section 232 is a vaporization type humidifier. Thereby, humidified air is supplied into the housing section 142. By supplying the humidified air, the humidifying step described in the above 3-2 can be performed, and the above described effect can be obtained. In addition, the first sorted materials M4-1 can be humidified, and thus it is possible to prevent the first sorted materials M4-1 from adhering to an inner wall of the housing section 142 due to electrostatic force.

The humidifying section 235 is disposed on the downstream of the sorting section 14. The humidifying section 235 is an ultrasonic humidifier that sprays water. Thereby, moisture can be supplied to the first web M5, and thus the amount of moisture in the first web M5 is adjusted. By adjusting the amount of moisture, the humidifying step described in the above 3-2 can be performed, and the above described effect can be obtained. In addition, it is possible to suppress the adsorption of the first web M5 to the mesh belt 151 due to electrostatic force. Thereby, the first web M5 is easily peeled off from the mesh belt 151 at a position where the mesh belt 151 is folded back by the tension roller 152.

The fragmenting section 16 is disposed on the downstream of the humidifying section 235. The fragmenting section 16 is a part that performs the fragmenting step of fragmenting the first web M5 that has been peeled from the mesh belt 151. The fragmenting section 16 includes a propeller 161 rotatably supported and a housing section 162 accommodating the propeller 161. Then, the first web M5 can be fragmented by the rotating propeller 161. The first web M5 is fragmented to be the fine fragment material M6. The fine fragment material M6 falls in the housing section 162.

The housing section 162 is coupled to the humidifying section 233. The humidifying section 233 is a vaporization type humidifier. Thereby, humidified air is supplied into the housing section 162. By supplying the humidified air, the humidifying step described in the above 3-2 can be performed, and the above described effect can be obtained. In addition, it is possible to prevent the fine fragment material M6 from adhering to an inner wall of the propeller 161 and an inner wall of the housing section 162 due to electrostatic force.

The mixing section 17 is disposed on the downstream of the fragmenting section 16. The mixing section 17 is a part that performs the mixing step of mixing the fine fragment material M6 and an additive agent. The mixing section 17 includes an additive agent supplying section 171, a tube 172, and a blower 173.

The tube 172 couples a housing section 162 of the fragmenting section 16 to a housing 182 of the dispersing section 18, and is a flow path through which the mixture M7 of the fine fragment material M6 and the additive agent passes.

The additive agent supplying section 171 is coupled in the middle of the tube 172. The additive agent supplying section 171 includes a housing section 170 in which the additive agent is accommodated, and a screw feeder 174 provided in the housing section 170. By rotating the screw feeder 174, the additive agent in the housing section 170 is extruded from the housing section 170 to be supplied into the tube 172. The additive agent supplied into the tube 172 is mixed with the fine fragment material M6 to be a mixture M7.

Here, examples of the additive agent supplied from the additive agent supplying section 171 include a binding agent for binding fibers to each other, a coloring agent for coloring fibers, an agglomeration inhibitor for suppressing fiber agglomeration, a flame retardant for making fibers and the like hard to burn, a paper strength enhancing agent for enhancing a paper strength of the sheet S, a defibrated material, and the like, and among these, one additive agent can be used singly, or two or more additive agents can be used in combination. In the following, a case where the additive agent is a starch P1 as a binding agent, particularly the starch P1 has a weight-average molecular weight of 40,000 or higher and 400,000 or lower, will be mainly described.

The starch P1 is supplied from the additive agent supplying section 171, so that the sheet S as a suitable molded product can be obtained even when a content of the starch in the fiber raw material M1 is relatively low, or a case where a relatively large proportion of the starch contained in the fiber raw material M1 is removed by a process in which the molded product producing device 100 is used. That is, the content of the starch in the sheet S as the finally obtained molded product can be sufficiently increased, the starch can be fused to the fibers constituting the sheet S with high adhesion, and as a result, the above described effects are more remarkably exhibited.

The starch P1 preferably satisfies the same conditions as the starch C2 as the constituent component of the composite C100 described in the above 1-2.

Thereby, the same effect as described above can be obtained.

As the additive agent supplied from the additive agent supplying section 171, instead of the starch P1, the composite of the present disclosure, that is, the composite containing a fiber and a starch that is fused to the fiber and that has a weight-average molecular weight of 40,000 or higher and 400,000 or lower may be used.

Thereby, for example, when the sheet material containing a fiber and a starch that is fused to the fiber and that has a weight-average molecular weight of 40,000 or higher and 400,000 or lower is used as the fiber raw material M1, even when the mixing step in the mixing section 17 is simplified, unintended variation of the composition of the second web M8, particularly unintended variation in the presence of the starch having a weight-average molecular weight of 40,000 or higher and 400,000 or lower at each site, can be suppressed. As a result, it is possible to suppress unintended variation and the like in the composition of the sheet S as the finally obtained molded product, and reliability of the sheet S can be further improved.

In the middle of the tube 172, the blower 173 is installed on the downstream of the additive agent supplying section 171. It is promoted that the fine fragment material M6 and the starch P1 are mixed with each other by an operation of a rotating section such as a blade included in the blower 173. The blower 173 can generate airstream toward the dispersing section 18. By this airstream, the fine fragment material M6 and the starch P1 can be agitated in the tube 172. Thereby, the mixture M7 is transported to the dispersing section 18 in a state where the fine fragment material M6 and the starch P1 are uniformly dispersed. Furthermore, the fine fragment material M6 in the mixture M7 is unraveled in a process of passing through the tube 172 to have a fine fiber shape.

As illustrated in FIG. 2, the blower 173 is electrically coupled to the control section 28, and an operation thereof is controlled. In addition, by adjusting the amount of air blown by the blower 173, the amount of air sent into the drum 181 can be adjusted.

Although it is not illustrated, an end of the tube 172 on the drum 181 side is bifurcated, and the bifurcated ends are coupled to an introduction port (not shown) formed on an end surface of the drum 181, respectively.

The dispersing section 18 illustrated in FIG. 2 is a part that performs the releasing step of unraveling and releasing the fibers that have been entangled with each other in the mixture M7. The dispersing section 18 includes the drum 181 that introduces and releases the mixture M7 that is a defibrated material, the housing 182 that accommodates the drum 181, and a drive source 183 that rotationally drives the drum 181.

The drum 181 is a cylindrical net body and is a sieve rotating about a central axis. By rotating the drum 181, fibers or the like in the mixture M7, which are smaller than mesh openings, can pass through the drum 181. At that time, the mixture M7 is unraveled and released together with air. That is, the drum 181 functions as a releasing section that releases a material containing fibers.

Although it is not illustrated, the drive source 183 includes a motor, a speed reducer, and a belt. The motor is electrically coupled to the control section 28 via a motor driver. The rotational force output from the motor is reduced by the speed reducer. The belt is, for example, an endless belt, and winds around an output axis of the speed reducer and an outer circumference of the drum. Thereby, the rotational force of the output axis of the speed reducer is transmitted to the drum 181 through the belt.

The housing 182 is coupled to the humidifying section 234. The humidifying section 234 is a vaporization type humidifier. Thereby, humidified air is supplied into the housing 182. The inside of the housing 182 can be humidified by this humidified air, and the humidifying step described in the above 3-2 can be performed, so that the above described effect can be obtained. In addition, it is possible to prevent the mixture M7 from adhering to an inner wall of the housing 182 due to electrostatic force.

The mixture M7 released from the drum 181 falls while being dispersed in the air, and directs toward the second web forming section 19 located below the drum 181. The second web forming section 19 is a part that performs the accumulating step of accumulating the mixture M7 to form the second web M8 that is an accumulated material. The second web forming section 19 includes a mesh belt 191, tension rollers 192, and a suction section 193.

The mesh belt 191 is a mesh member, and in the illustrated configuration, the mesh belt 191 is an endless belt. The mixture M7 dispersed and released by the dispersing section 18 is accumulated on the mesh belt 191. The mesh belt 191 winds around four tension rollers 192. The mixture M7 on the mesh belt 191 is transported to the downstream by rotational drive of the tension rollers 192.

In the illustrated configuration, the mesh belt 191 is used as an example of the mesh member, but the present disclosure is not limited thereto, and for example, a flat plate shape may be used.

A large proportion of the mixture M7 on the mesh belt 191 has a size larger than mesh openings of the mesh belt 191. Thereby, the mixture M7 is restricted from passing through the mesh belt 191 and thus accumulated on the mesh belt 191. The mixture M7 is transported to the downstream together with the mesh belt 191 while being accumulated on the mesh belt 191, and is formed as the second web M8 having a layered shape.

The suction section 193 is a suction mechanism sucking air below the mesh belt 191. Thereby, the mixture M7 can be sucked onto the mesh belt 191, and thus it is promoted that the mixture M7 is accumulated on the mesh belt 191.

A tube 246 is coupled to the suction section 193. A blower 263 is installed in the middle of the tube 246. By operating the blower 263, a suction force can be generated at the suction section 193.

The humidifying section 236 is disposed on the downstream of the dispersing section 18. The humidifying section 236 is the same ultrasonic humidifier as the humidifying section 235. Thereby, moisture can be supplied to the second web M8, and thus the amount of moisture in the second web M8 is adjusted. By adjusting the amount of moisture, the humidifying step described in the above 3-2 can be performed, and the above described effect can be obtained. In addition, it is possible to suppress the adsorption of the second web M8 to the mesh belt 191 due to electrostatic force. Thereby, the second web M8 is easily peeled off from the mesh belt 191 at a position where the mesh belt 191 is folded back by the tension roller 192.

The total amount of moisture added from the humidifying section 231 to the humidifying section 236 is not particularly limited, but a moisture content of the molding raw material at the end of the humidifying step, that is, a ratio of the mass of moisture contained in the second web M8 to the mass of the second web M8 in a state of being humidified by the humidifying section 236 is preferably 15% by mass or more and 50% by mass or less, more preferably 18% by mass or more and 45% by mass or less, and even more preferably 20% by mass or more and 40% by mass or less.

The molding section 20 is disposed on the downstream of the second web forming section 19. The molding section 20 is a part that performs the sheet forming step of forming the sheet S from the second web M8 that is a molding raw material. The molding section 20 includes a pressurizing section 201 and a heating section 202.

The pressurizing section 201 has a pair of calendar rollers 203, and can pressurize the second web M8 between the calendar rollers 203 without heating. Thereby, a density of the second web M8 is increased. This second web M8 is transported toward the heating section 202. One of the pair of calendar rollers 203 is a driving roller driven by an operation of a motor (not shown), and the other is a driven roller.

The heating section 202 has a pair of heating rollers 204, and can pressurize the second web M8 between the heating rollers 204 while heating the second web M8. By this heating and pressurization, in the second web M8, the starch having absorbed moisture through humidification is pregelatinized and exhibits viscosity, and the fibers are bound to each other through this starch that has exhibited viscosity. Thereby, the sheet S is formed. The sheet S is transported toward the cutting section 21. One of the pair of heating rollers 204 is a driving roller driven by an operation of a motor (not shown), and the other is a driven roller.

The cutting section 21 is disposed on the downstream of the molding section 20. The cutting section 21 is a part that performs the cutting step of cutting the sheet S. The cutting section 21 includes a first cutter 211 and a second cutter 212.

The first cutter 211 cuts the sheet S in a direction intersecting the transportation direction of the sheet S, particularly in a direction orthogonal to the transportation direction.

The second cutter 212 cuts the sheet S in a direction parallel to the transportation direction of the sheet S on the downstream of the first cutter 211. With this cutting, unnecessary portions at both ends in the width direction of the sheet S are removed to adjust the width of the sheet S, and the cut-removed portions are so-called “edges”.

In this way, the sheet S having a desired shape and size can be obtained by cutting the sheet S with the first cutter 211 and the second cutter 212. Then, the sheet S is further transported to the downstream and stock in the stock section 22.

The molding section 20 is not limited to the above described configuration to mold the sheet S, and for example, configurations to form the molded product into a block shape, a spherical shape, or the like may be employed.

Each section included in the molded product producing device 100 is electrically coupled to the control section 28 described later. An operation of each of these sections is controlled by the control section 28.

Although the preferred embodiment of the present disclosure is described above, the present disclosure is not limited thereto.

For example, each section constituting the molded product producing device used for producing the molded product can be replaced with any constitution capable of exhibiting the same function. Furthermore, any components may be added.

In the above-described embodiment, in the method for producing a molded product using the molded product producing device, it was described that the fiber raw material containing the fibers and the starch having the predetermined molecular weight is used, and in the mixing section, the fine fragment material that is obtained from the defibrated material of the fiber raw material are mixed with the starch having the predetermined molecular weight supplied from the additive agent supplying section. However, when the fiber raw material containing the fibers and the starch having the predetermined molecular weight is used, there is not necessary to add the starch having the predetermined molecular weight during the production of the molded product. In this case, the additive agent supplying section can be omitted. Accordingly, the fragmenting section, the mixing section, the dispersing section, the second web forming section, and the like can be omitted, and the first web may be directly supplied to the molding section.

The method for producing a molded product of the present disclosure may include the above described molding raw material preparing step, humidifying step, and molding step. Furthermore, a molded product producing device is not limited to the above described molded product producing device, and any devices may be used.

### EXAMPLES

Next, specific examples of the present disclosure will be described.

### 4. Preparation of Starch

### Preparation Example 1

A starch having a weight-average molecular weight of 1,300,000 (G-800 manufactured by NIPPON STARCH CHEMICAL CO., LTD.) was prepared, and after suspending this starch in water, sulfuric acid was allowed to act under a condition in which the starch does not gelatinize and was well mixed. Subsequently, the mixture was stirred for 12 hours, dried at 50° C. for 24 hours, and then dried until a moisture content was 10% by mass or less, and thereafter heated at 120° C. to 180° C. to obtain a starch with a weight-average molecular weight of 400,000.

### Preparation Examples 2 to 6

A starch having the adjusted weight-average molecular weights was obtained in the same manner as in Preparation Example 1, except that by changing processing conditions (sulfuric acid concentration, and stirring time) for the starch having a weight-average molecular weight of 1,300,000 (G-800 manufactured by NIPPON STARCH CHEMICAL CO., LTD.), weight-average molecular weights of the finally obtained starches were adjusted to be represented by values illustrated in Table 1.

Conditions for the starches having the adjusted weight-average molecular weights obtained in respective Preparation Examples are summarized and illustrated in Table 1.

TABLE 1
Table 1

| | Weight-average molecular |
|---|---|
| | weight [×10⁴] |
| Preparation Example 1 | 40 |
| Preparation Example 2 | 30 |
| Preparation Example 3 | 15 |
| Preparation Example 4 | 4 |
| Preparation Example 5 | 60 |
| Preparation Example 6 | 1 |

### 5. Production of Composite and Molded Product

### Example A1

The sheet S as a molded product was produced by using the molded product producing device 100 as illustrated in FIG. 2 as follows.

First, as the fiber raw material M1, a plurality of G80s (manufactured by Mitsubishi Paper Mills Limited) made of cellulose fibers were prepared, the plurality of G80s were accommodated in an accommodating section of the sheet supply device 11, and the starch prepared in Preparation Example 1 was accommodated in the housing section 170 of the additive agent supplying section 171.

Then, as described above, the molded product producing device 100 was operated.

As a result, in the mixing section 17, the cellulose fibers and the starch were mixed at a predetermined ratio, and the mixture M7 as a composite containing the cellulose fibers and the starch was obtained.

The mixture M7 obtained in the mixing section 17 passed through the dispersing section 18 and became the second web M8 as a composite containing the cellulose fibers and the starch in the second web forming section 19.

The humidifying section 231, humidifying section 232, humidifying section 233, humidifying section 234, humidifying section 235, and humidifying section 236 each humidify the second web M8, and a ratio of the mass of moisture contained in the second web M8 to the mass of the second web M8 in a state of being humidified at the humidifying section 236 was 30% by mass.

The second web M8 was heated and pressurized by the molding section 20 to be the sheet S that is a long molded product. The heating temperature at the molding section 20 was 80° C., the heating time was 15 seconds, and the pressurization at the molding section 20 was performed at 70 MPa.

The sheet S that is a long molded product obtained in this way was cut by the cutting section 21 to be the sheet S having an A4 size.

### Examples A2 to A9

A composite and a molded product were produced in the same manner as in Example A1, except that kinds of starches supplied from the additive agent supplying section 171, mixing ratios of the starches and the cellulose fibers in the mixing section, heating and pressurizing conditions, and the moisture content of the second web that is a molding raw material, at the end of the humidifying step, were set as illustrated in Table 2.

### Comparative Example A1

A molded product was produced in the same manner as in Example A1, except that the starch was not supplied from the additive agent supplying section 171. The molded product of the present Comparative Example obtained in this way consisted of only cellulose fibers and did not contain the starch.

### Comparative Examples A2 and A3

Composites and molded products were produced in the same manner as in A1, except that kinds of starches supplied from the additive agent supplying section 171 were changed from the starch prepared in Preparation Example 1 to the starch prepared in Preparation Example 5 and the starch prepared in Preparation Example 6, respectively.

Configurations of the molded products of respective Examples and Comparative Examples and production conditions of the molded products are summarized in Table 2. The fibers contained in the molded product obtained in each case of Examples and Comparative Examples had an average length of 0.1 mm or higher and 10 mm or lower, an average thickness of 0.05 mm or higher and 2.0 mm or lower, and an average aspect ratio was 10 or higher and 1000 or lower. In addition, the moisture content of the second web that is a composite obtained according to each of Examples and Comparative Examples when being left in an environment of 27° C./98% RH for 2 hours is also illustrated in Table 2. These values were determined by taking off a part of the second web M8 before heating and pressurizing the second web M8 at the molding section 20, drying the part of the second web M8 in a constant temperature and humidity bath adjusted to 27° C./10% RH for 1 day, leaving the part in an environment of 27° C./98% RH for 2 hours, and then measuring the resultant part.

TABLE 2
Table 2

| | Constitution of molded product | | | | | |
|---|---|---|---|---|---|---|
| | Cellulose | Starch | | | | |
| | fiber | | Weight-average | | | |
| | Content | | molecular | Content | | |
| | [% by | | weight | [% by | Thickness | Density |
| | mass] | Kinds | [×10⁴] | mass] | [mm] | [g/m³] |
| Example A1 | 92.0 | Preparation | 40 | 6.0 | 0.1 | 0.8 |
| | | Example 1 | | | | |
| Example A2 | 92.0 | Preparation | 30 | 6.0 | 0.1 | 0.8 |
| | | Example 2 | | | | |
| Example A3 | 92.0 | Preparation | 15 | 6.0 | 0.1 | 0.8 |
| | | Example 3 | | | | |
| Example A4 | 92.0 | Preparation | 8 | 6.0 | 0.1 | 0.8 |
| | | Example 4 | | | | |
| Example A5 | 99.0 | Preparation | 15 | 1.0 | 0.1 | 0.8 |
| | | Example 3 | | | | |
| Example A6 | 98.0 | Preparation | 15 | 2.0 | 0.1 | 0.8 |
| | | Example 3 | | | | |
| Example A7 | 95.0 | Preparation | 15 | 4.0 | 0.1 | 0.8 |
| | | Example 3 | | | | |
| Example A8 | 90.0 | Preparation | 15 | 10.0 | 0.1 | 0.8 |
| | | Example 3 | | | | |
| Example A9 | 85.0 | Preparation | 15 | 15.0 | 0.1 | 0.8 |
| | | Example 3 | | | | |
| Comparative | 100 | — | — | — | 0.1 | 0.8 |
| Example A1 | | | | | | |
| Comparative | 92.0 | Preparation | 60 | 8.0 | 0.1 | 0.8 |
| Example A2 | | Example 5 | | | | |
| Comparative | 92.0 | Preparation | 4 | 8.0 | 0.1 | 0.8 |
| Example A3 | | Example 6 | | | | |

| | | | | | Moisture content |
|---|---|---|---|---|---|
| | | | | | of second web in |
| | Moisture content | Heating and | | | case of being left |
| | of second web at | pressurizing condition | | | for two hours |
| | end of | | Heating | | under environment |
| | humidification | Heating | time | | of 27° C. and |
| | step [% by | temperature | [for | Pressure | 98% RH [% by |
| | mass] | [° C.] | second] | [MPa] | mass] |
| Example A1 | 27 | 150 | 15 | 60 | 27 |
| Example A2 | 27 | 150 | 15 | 60 | 26 |
| Example A3 | 26 | 150 | 15 | 60 | 26 |
| Example A4 | 26 | 150 | 15 | 60 | 27 |
| Example A5 | 24 | 150 | 15 | 60 | 21 |
| Example A6 | 25 | 150 | 15 | 60 | 22 |
| Example A7 | 26 | 150 | 15 | 60 | 22 |
| Example A8 | 28 | 150 | 15 | 60 | 24 |
| Example A9 | 28 | 150 | 15 | 60 | 27 |
| Comparative | 18 | 150 | 15 | 60 | 17 |
| Example A1 | | | | | |
| Comparative | 28 | 150 | 15 | 60 | 19 |
| Example A2 | | | | | |
| Comparative | 26 | 150 | 15 | 60 | 22 |
| Example A3 | | | | | |

### 6. Evaluation

The following evaluations were performed on the molded products of respective Examples and Comparative Examples.

### 6-1. Water Absorption Characteristics

The molded products of respective Examples and Comparative Examples were placed into a constant temperature bath at 27° C./98% RH so as not to overlap each other, left for 2 hours, and the moisture content in the molded product at that time was determined and evaluated according to the following criteria. It can be said that the higher the moisture content, the better the water absorption characteristics.

A: Moisture content is 25% by mass or more.

B: Moisture content is 20% by mass or more and less than 25% by mass.

C: Moisture content is 15% by mass or more and less than 20% by mass.

D: Moisture content is less than 15% by mass.

### 6-2. Specific Tensile Strength

The molded products of respective Examples and Comparative Examples were measured according to JIS P8113 using AUTOGRAP AGC-X 500N (manufactured by Shimadzu Corporation), and specific tensile strengths thereof were determined and evaluated according to the following criteria.

A: Specific tensile strength is 25 N·m/g or higher.

B: Specific tensile strength is 20 N·m/g or higher and lower than 25 N·m/g.

C: Specific tensile strength is 15 N·m/g or higher and lower than 20 N·m/g.

D: Specific tensile strength is lower than 15 N·m/g.

These results are summarized in Table 3.

TABLE 3
Table 3

| | Absorbing properties | Tensile strength |
|---|---|---|
| Example A1 | B | A |
| Example A2 | A | A |
| Example A3 | A | A |
| Example A4 | A | A |
| Example A5 | B | B |
| Example A6 | A | B |
| Example A7 | A | A |
| Example A8 | A | B |
| Example A9 | A | B |
| Comparative Example A1 | D | D |
| Comparative Example A2 | D | D |
| Comparative Example A3 | A | C |

As is clear from Table 3, excellent results were obtained in respective Examples. On the other hand, in respective Comparative Examples, satisfactory results were not obtained.

### 7. Production of Molded Product Using Sheet S as Raw Material for Molded Product

### Example B1

The sheet S as a molded product was produced in the same manner as in Example A1, except that the sheet S produced in Example A1 was used as the fiber raw material M1, and the starch was not supplied from the additive agent supplying section 171.

### Examples B2 to B9

Sheets S as a molded product were produced in the same manner as in Example B1, except that the sheets S produced in Examples A2 to A9 were used as the fiber raw material M1 respectively, instead of the sheet S produced in Example A1.

### Comparative Examples B1 to B3

Sheets S as a molded product were produced in the same manner as in Example B1, except that the sheets S produced in Comparative Examples A1 to A3 were used as the fiber raw material M1 respectively, instead of the sheet S produced in Example A1.

The molded product obtained in each case of Examples B1 to B9 and Comparative Examples B1 to B3 contained no components other than constituting materials of the fiber raw material M1. The fibers contained in the molded product obtained in each case of Examples B1 to B9 and Comparative Examples B1 to B3 had an average length of 0.1 mm or higher and 10 mm or lower, and an average thickness of 0.05 mm or higher and 2.0 mm or lower, and an average aspect ratio is 10 or higher and 1000 or lower. In these average length, average thickness, and average aspect ratio of the fiber, a change rate from the average length, the average thickness, and the average aspect ratio of the fibers contained in the corresponding fiber raw material M1 was 30% or less in each case.

### 8. Evaluation

The following evaluations were performed on Examples B1 to B9 and Comparative Examples B1 to B3.

### 8-1. Specific Tensile Strength

The molded products of Examples B1 to B9 and Comparative Examples B1 to B3 were measured according to JIS P8113 using AUTOGRAP AGC-X 500N (manufactured by Shimadzu Corporation), and specific tensile strengths thereof were determined and evaluated according to the following criteria.

A: Specific tensile strength is 20 N·m/g or higher.

B: Specific tensile strength is 15 N·m/g or higher and lower than 20 N·m/g.

C: Specific tensile strength is 10 N·m/g or higher and lower than 15 N·m/g.

D: Specific tensile strength is lower than 10 N·m/g.

These results are summarized in Table 4.

TABLE 4
Table 4

| | Tensile strength |
|---|---|
| Example B1 | A |
| Example B2 | B |
| Example B3 | A |
| Example B4 | B |
| Example B5 | C |
| Example B6 | B |
| Example B7 | B |
| Example B8 | A |
| Example B9 | A |
| Comparative Example B1 | D |
| Comparative Example B2 | D |
| Comparative Example B3 | D |

As is clear from Table 4, excellent results were obtained in Examples B1 to B9. On the other hand, in Comparative Examples B1 to B3, satisfactory results were not obtained.

When the molded product was produced in the same manner as described above except that the heating temperature in the molding step was variously changed in a range of 60° C. or higher and 180° C. or lower, and the same evaluation as described above was performed, the same results as described above were obtained. When the molded product was produced in the same manner as described above except that the pressurization in the molding step was variously changed in a range of 0.1 MPa or higher and 100 MPa or lower, and the same evaluation as described above was performed, the same results as described above were obtained. When the molded product was produced in the same manner as described above except that the humidification amount in each humidifying section is adjusted, and the ratio of the mass of moisture contained in the second web M8 to the mass of the second web M8 in a state of being humidified by the humidifying section 236 was variously changed in a range of 15% by mass or more and 50% by mass or less, the same results as described above were obtained.

What is claimed is:

1. A composite comprising:
a fiber; and
a starch, wherein
at least a part of the starch is fused to the fiber, and
a weight-average molecular weight of the starch is 40,000 or higher and 400,000 or lower.

2. The composite according to claim 1, wherein a content of the starch is 2.0% by mass or more and 15.0% by mass or less with respect to a total amount of the composite.

3. The composite according to claim 1, wherein a moisture content of the composite is 20% by mass or more and 55% by mass or less when being left for two hours under an environment of 27° C./98% RH.

4. The composite according to claim 1, wherein the fiber is formed of a substance containing at least one chemical structure of a hydroxyl group, a carbonyl group, or an amino group.

5. The composite according to claim 1, wherein the fiber is a cellulose fiber.

6. A molded product comprising the composite according to claim 1.

7. The molded product according to claim 6, wherein the molded product is formed in a sheet shape.

8. A method for producing a molded product comprising:
a molding raw material preparing step of preparing a molding raw material containing a fiber and a starch that has a weight-average molecular weight of 40,000 or higher and 400,000 or lower;
a humidifying step of humidifying the molding raw material; and
a molding step of molding the molding raw material into a predetermined shape by heating and pressurizing the molding raw material.

9. The method for producing a molded product according to claim 8, wherein a moisture content of the molding raw material at the end of the humidifying step is 15% by mass or more and 50% by mass or less.

10. The method for producing a molded product according to claim 8, wherein the molding raw material contains a defibrated material of a sheet-shaped composite containing the fiber and the starch.
